(19) United States
(12) Patent Application Publication
(10) Pub. No.: US 2024/0428051 A1
(43) Pub. Date: Dec. 26, 2024

(54) METHOD AND SYSTEM FOR ANALYSING OPERATION OF A ROBOT

(71) Applicant: KUKA Deutschland GmbH, Augsburg (DE)

(72) Inventor: Zhicong Xian, Augsburg (DE)

(73) Assignee: KUKA Deutschland GmbH, Augsburg (DE)

(21) Appl. No.: 18/683,017

(22) PCT Filed: Aug. 1, 2022
(86) PCT No.: PCT/EP2022/071511

§ 371 Date: Feb. 12, 2024

(30) Foreign Application Priority Data
Aug. 11, 2021 (DE) 10 2021 208 769.8

(51) Int. Cl. G06N 3/0455; B25J 9/16

(52) U.S. Cl. CPC G06N 3/0455; B25J 9/1628; B25J 9/1674

(57) ABSTRACT

A method for analyzing an operation of a robot includes performing a training phase by obtaining a first dataset containing at least one temporal characteristic of at least one state parameter of a first robot and training an artificial neural network. The artificial neural network includes a first autoencoder having an encoder that maps the first dataset onto temporal characteristic patterns and the activation thereof, and a decoder that uses these temporal characteristic patterns to reconstruct the first dataset; and a second autoencoder having an encoder that maps the temporal characteristic patterns and the activation thereof onto pattern groups, and a decoder that uses these pattern groups to reconstruct the temporal characteristic patterns and the activation thereof. The method further includes performing a monitoring phase by obtaining a second dataset containing at least one temporal characteristic of the at least one state parameter of the first or of a second robot; and identifying at least one of the pattern groups of the trained second autoencoder within the second dataset.

### CROSS-REFERENCE TO RELATED APPLICATIONS

This application is a national phase application under 35 U.S.C. § 371 of International Patent Application No. PCT/EP2022/071511, filed Aug. 1, 2022 (pending), which claims the benefit of priority to German Patent Application No. DE 10 2021 208 769.8, filed Aug. 11, 2021, the disclosures of which are incorporated by reference herein in their entirety.

### TECHNICAL FIELD

The present invention relates to a method and system for analyzing an operation of a robot and a computer program or computer program product for this purpose.

### SUMMARY

An object of one embodiment of the present invention is to analyze an operation of a robot or to identify significant patterns or sections in temporal characteristics of robot data.

In one embodiment, this allows a robot anomaly or an event, for example a contact with the environment, to be detected, or a temporal characteristic can also be classified, for example a specific robot movement within a working process can be recognized. In one embodiment, an operation of a robot can thus be analyzed, monitored and/or modified, for example by checking detected robot anomalies or performing, in particular predictive maintenance on the basis of detected robot anomalies, by modifying an operating sequence on the basis of a detected event, for example environmental contact, and/or monitoring for this event, or the like.

This object is achieved by a method having the features of claim 1. Claims 9, 10 protect, respectively, a system or computer program or computer program product for carrying out a method described herein. The dependent claims relate to advantageous developments.

According to one embodiment of the present invention, a method of analyzing an operation of a robot comprises performing a training phase comprising the steps of:
obtaining, in one embodiment determining, a first data set having one or more temporal characteristics of (in each case) one or more state parameters of a first robot; and training an artificial neural network.

According to one embodiment of the present invention, this artificial neural network has:
a first autoencoder with an encoder that maps the first data set to temporal characteristic patterns and their activation, and a decoder that reconstructs the first data set with these temporal characteristic patterns, and
a second autoencoder having an encoder which maps the temporal characteristic patterns and their activation to pattern groups and, in a further development, their activation, and a decoder which reconstructs the temporal characteristic patterns and their activation with these pattern groups and in the development of the activation.

According to one embodiment of the present invention, after performing the training phase, the method comprises performing a monitoring phase which comprises the steps of:
obtaining a second data set with one or more temporal characteristics of the state parameter(s) of the first or a second robot; and
identifying at least one of the pattern groups of the trained second autoencoder within the second data set.

This identification can represent an analysis/analyzing of the operation of this robot for which the second data set has been obtained, within the meaning of the present invention. Likewise, in one embodiment, a (further) analysis can be carried out on the basis of this identified at least one pattern group, in one embodiment automatically and/or manually or by a user. In one embodiment, a temporal characteristic can comprise, in particular can be, a time series.

In one embodiment, the first autoencoder, which can also be referred to as a low-level autoencoder, has at least one variational autoencoder.

The second autoencoder can also be referred to as a high-level autoencoder.

In one embodiment, the encoder of the second autoencoder has at least one attention-based artificial neural network, in particular at least one multi-head attraction block. Additionally or alternatively, in one embodiment, the decoder of the second autoencoder has at least one capsule neural network.

In one embodiment, such autoencoders can be used to identify pattern groups in time sequences of robot data, in particularly efficient machine learning.

In one embodiment, the state parameter depends on at least one position and/or orientation of a robot-fixed reference, in particular of an end effector and/or one or more axes or drives, and/or of at least one axial load of the (corresponding) robot, in one development it indicates this/these position(s), and/or orientation(s) and/or axial load(s) and/or time changes of this/these position(s), and/or orientation(s) and/or axial load(s). Additionally or alternatively, in one embodiment, the state parameter is detected by means of one or more robot or robot-fixed sensors.

Such state parameters are particularly suitable due to their significance in order to monitor and/or modify an operation of a robot.

In one embodiment, the identified pattern group is marked in the second data set, in one embodiment optically or visually. As a result, in one embodiment, a user can concentrate on particularly relevant sections in temporal characteristics.

In one embodiment, a robot anomaly is detected on the basis of the identified pattern group. As a result, in one embodiment, in particular anticipatory maintenance of the robot can be improved.

Additionally or alternatively, in one embodiment, an event is detected, for example an unforeseen or planned environmental contact. As a result, in one embodiment, an operation of the robot can be monitored in a particularly advantageous manner, for example for unforeseen collisions, and/or modified, for example depending on a scheduled environmental contact, for example an action can be carried out depending on a scheduled environmental contact.

Additionally or alternatively, in one embodiment, the temporal characteristic of the second data set is classified, in one embodiment as to whether the robot has carried out a specific action and/or whether certain boundary conditions, in particular environmental conditions, were present. The corresponding time course can then be used for machine learning based on this (automatic) classification, for example.

Only a few examples of how identified pattern groups within a data set of one or more robot state parameter temporal characteristics can be advantageously used to analyze, monitor and/or modify an operation of a robot have been presented above. In general, in one embodiment, an operation of the first or second robot is analyzed, monitored and/or modified on the basis of the identified pattern group, in one embodiment on the basis of the pattern group marked in the second data set, and/or the detected robot anomaly, and/or the detected event, and/or the classified temporal characteristic of the second data set. As stated above, the identification may already constitute an analysis/analyzing of the operation of the robot within the meaning of the present invention or equally in one embodiment, a (further) analysis can be performed on the basis of this identified at least one pattern group.

According to one embodiment of the present invention, a system for analyzing an operation of a robot, in particular hardware and/or software, in particular programming, is configured to carry out a method described herein and/or has:
means for performing a training phase, comprising the steps of:
   obtaining a first data set with at least one temporal characteristic of at least one state parameter of a first robot; and
   training an artificial neural network, which has
      a first autoencoder with an encoder that maps the first data set to temporal characteristic patterns and their activation, and a decoder that reconstructs the first data set with these temporal characteristic patterns, and
      a second autoencoder with an encoder which maps the temporal characteristic patterns and their activation to pattern groups, and a decoder which reconstructs the temporal characteristic patterns and their activation with these pattern groups;
   and
means for performing a monitoring phase, comprising the steps of:
   obtaining a second data set with at least one temporal characteristic of the at least one state parameter of the first or a second robot; and
   identifying at least one of the pattern groups of the trained second autoencoder within the second data set.

In one embodiment, the means for performing a training phase comprises:
means for obtaining a first data set with at least one temporal characteristic of at least one state parameter of a first robot;
the artificial neural network which has the first autoencoder and the second autoencoder, and/or
means for training the artificial neural network.

In one embodiment, the means for performing a monitoring phase comprises:
means for obtaining a second data set with at least one temporal characteristic of the at least one state parameter of the first or a second robot; and/or
means for identifying at least one of the pattern groups of the trained second autoencoder within the second data set.

In one embodiment, the system or its means comprises:
means for marking the identified pattern group in the second data set;
means for detecting a robot anomaly and/or an event on the basis of the identified pattern group and/or classification of the temporal characteristic of the second data set on the basis of the identified pattern groups; and/or
means for analyzing, monitoring and/or modifying an operation of the robot on the basis of the identified pattern group, in particular on the basis of the pattern group marked in the second data set, and/or the detected robot anomaly, and/or the detected event, and/or the classified temporal characteristic of the second data set.

A system and/or a means within the meaning of the present invention may be designed in hardware and/or in software, and in particular may comprise at least one data-connected or signal-connected, in particular digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be such that it embodies or is capable of executing the methods described herein, so that the processing unit can execute the steps of such methods and thus in particular identify the pattern group(s) and/or analyze, monitor and/or modify operation of the robot. In one embodiment, a computer program product may comprise, in particular be, a storage medium, in particular computer-readable and/or non-volatile, for storing a program or instructions or with a program stored thereon or with instructions stored thereon. In one embodiment, execution of said program or instructions by a system, in particular a computer or an arrangement of a plurality of computers, causes the system, in particular the computer or computers, to carry out a method described herein or one or more steps thereof, or the program or instructions are adapted to do so.

In one embodiment, one or more, in particular all, steps of the method are performed completely or partially automatically, in particular by the system or its means.

In one embodiment, the system comprises the robot.

In one embodiment, the monitoring phase is carried out online, in one embodiment during a working process of the first or second robot. In one embodiment, the second data set results from a working process of the first or second robot. As a result, no separate reference process has to be carried out in one embodiment.

In one embodiment, the artificial neural network attempts to generate the same output as the time characteristic of the received first data set and simultaneously extract recurring and discriminative subsequences from the time course. Based on the presence and localization of different recurring and discriminative subsequences, in one embodiment a temporal characteristic is then clustered into a predefined number of groups. In the present case, an artificial neural network with a bottleneck is referred to as autoencoder for reconstructing the original input signal.

In one embodiment, the first or low-level autoencoder attempts to extract different but also recurring time characteristic subsequences during the reconstruction of the input time characteristics.

In one embodiment, the first autoencoder can be designed based on the principles described in greater detail in Kirschbaum, E. et al. (2019): “LeMoNADe: Learned Motif and Neuronal Assembly Detection in calcium imaging videos”, International Conference on Learning Representations. Accordingly, reference is additionally made to this article, and its content is incorporated by reference into the present disclosure in its entirety.

In one embodiment, the first data set has at least one n-dimensional time series x∈ [symbol] ^{T×d} with T time steps and d state parameters which are assigned to a time step, in particular stored for this purpose. It can be assumed that each sample in the data set is an additive mixture of M repeating (temporal characteristic) patterns of the maximum time length F. At each time step t=1, . . . , T and for each motif m=1, . . . , M of a recurring time series subsequence, a latent random variable zₜ^{m}∈{0, 1} represents an occurrence or activation encoding for the m-th pattern. As in Kirschbaum, in one embodiment, a Bernoulli distribution is used to model the latent random variables. In one embodiment, the loss function for training comprises a reconstruction error [symbol] _{z˜q}_{_{φ(z|x)}} [log p_{θ}(x|z)], wherein q_{φ(z|x)} represents the encoder with parameters ϕ for inferring latent variables z from an input x and a regularization term for enforcing a spatial latent distribution that, in one embodiment, implies that patterns at each location should be mutually exclusive.

In one embodiment, the second or high-level autoencoder attempts to cluster an input time series into different groups. It can be assumed that an input time series is composed of a plurality of time series subsequences or temporal characteristic patterns which are extracted from the first or low-level autoencoder. Irrespective of the numbering of low-level time series segments, the second or high-level autoencoder, in one embodiment, attempts to recognize whether a new subsequence is present in the current input time series, but is absent in all past input time series. If this is the case, the second or high-level autoencoder classifies this time series as a new class. In one embodiment, the second high-level autoencoder performs clustering based on the composition of low-level time series subsequences.

To enforce the position variant composition operation, it is considered in one embodiment as a set operation, and a set transformer with position embeddings for the sequence orders is used as the encoder of the high-level autoencoder. A set transformer is an attention-based neural network for modeling interactions between sets of data. In one embodiment, it consists of one or more multihead attention bocks (MAB) with learnable parameters ω, which can be defined as follows (in this regard, reference is made to Lee, J. et al. (2019), “Set Transformer: A Framework for Attention-based Permutation-Invariant Neural Networks”, Proc. of the 36th Int. Conference on Machine Learning, pp. 3744-3753, and the contents of this article are incorporated by reference into the present disclosure in their entirety):

Let there be two d-dimensional vector sets: X, Y∈ [symbol] ^{n×d},

MAB(X, Y)=LayerNorm(H+rFF(H)), wherein H=LayerNorm(X+multihead (X, Y, Y; ω) wherein rFF is a row-like feedforward layer, and each row in H is processed independently and in the same way. “LayerNorm” stands for layer normalization which normalizes the activities of the neurons of a layer. By means of the layer normalization, in one embodiment, the dynamics hidden neuron states can advantageously stabilized, and the training time can thereby be reduced.

Multihead (X, Y, Y; ω) is also referred to as a multi-head attention or attentiveness and represents a way to calculate relationships between neurons in an artificial neural network. In one embodiment, this comprises three variables: “query”, “key” and “values”. In one embodiment, after the extraction of primitive time-series or temporal characteristic patterns in the first or low-level autoencoder, an attempt is made to recognize more complex patterns which are composed of these extracted low-level time series subsequences, and which should reflect a visual form of an input time series. In one embodiment, a d dimensional vector set X is used as a query for attention, in another embodiment a list of detected low-level time series subsequences. The output/“values” Y after an attention operation should be a composition of detected low-level time series patterns, and the “keys” of this employed attention operation are, in one embodiment, some, preferably all, possible combinations of one, preferably all, low-level time series subsequences that are undetected in a training data set which results in the “query” set. This type of attraction operation is also referred to as self attention.

The calculation of the pairwise association between “query” and “key” sets can be computationally complex. This can be improved in one embodiment by multi-head attention. In one embodiment, multi-head attention projects query (Q)/key (K)/values (V), onto lower-dimensional h common subspaces, i.e. d_{q}^{M}, d_{q}^{M}, dᵥ^{M}-dimensional vectors. An attention operation (Att(⋅; ωⱼ)) is applied to each of these h projections. In one embodiment, multi-head attention enables the model to access information from different representations or subspaces together. In one embodiment, the output is a linear transformation of the linkage of all subspace attention outputs.

In one embodiment, positional information of elements in query/key/sentences is represented using trigonometric functions, in one embodiment sine and cosine functions, in one embodiment in the form (in this regard, reference is additionally made to Soricut, Z. L., Albert: A (2020), “A Lite BERT for Self-supervised Learning of Language Representations”, Proc. of ICLR 2020, and the contents of this article are incorporated by reference into the present disclosure in their entirety):

$${p}_{i}^{( n ) [ j ]} = \{ \begin{matrix}sin ( i \cdot {c}^{\frac{j}{d}} ) + sin ( n \cdot {c}^{\frac{j}{d}} ) if j is even \\ cos ( i \cdot {c}^{\frac{j - 1}{d}} ) + cos ( n \cdot {c}^{\frac{j - 1}{d}} ) if j is odd\end{matrix}$$

with pᵢ⁽ⁿ⁾[j] as the position embedding for the i-th element in the set and the j-th dimension of position invariant embeddings for the i-th element in the set with total size d, where c is a constant, and in one embodiment is between 10⁻⁵ and 10⁻³, and in one embodiment: c=10⁻⁴

In one embodiment, the position information is injected by adding the position code to the projected common space of the query and key vectors.

In one embodiment, the output of the above-described set transformer represents a list of candidate combinations of determined low-level time series subsequences or patterns in each input, and/or corresponds to a list of proposed complex candidate patterns or pattern groups.

In one embodiment, the set transformer is used as an encoder of the second or high-level autoencoder. Additionally or alternatively, in one embodiment, a capsule neural network or capsule module is used as a decoder of the second or high-level autoencoder. In one embodiment, the product of a capsule operation is a vectorial value which provides the activation of certain features and additionally an embedding in order to describe the activation features, for example a localization.

In one embodiment, the capsule neural network can be designed on the basis of the principles described in more detail in Kosiork, A. et al. (2019), “Stack capsule autoencoders”, Advances in Neural Information Processing Systems, pp. 15512-15522. Accordingly, reference is additionally made to this article, which is incorporated by reference into the present disclosure in its entirety.

It can be assumed that a complex time series pattern or a pattern group has the same length as input time series but with instance-dependent transformation. For example, a time series of the same type can look visually differently due to different sampling rates. However, these are only variations of a standard canonical time series of this type. In one embodiment, a capsule represents such a typical time series of a specific type, and the associated embedding describes a warping variation of this standard. Conversely, localization of the contained characteristic time series subsequences can be derived from a complex time series pattern.

In one embodiment, the latent space of the second or high-level autoencoder has clustered groups or pattern groups of determined characteristic low-level time series segments or temporal characteristic patterns. In one embodiment, the latent space is represented in the form of capsules, and each represents a clustered group and its associated embedding.

In one embodiment, the target of the second or high-level autoencoder, the clustered groups, which represent complex patterns of the input data length, must be trained. The derived localization operations of the clustered group over the positions of the low-level time series subsegments match those which were learned by the first or low-level autoencoder.

In one embodiment of the present invention, time-series patterns are extracted without human supervision, and extracted patterns are generalized to other unknown new robot state parameter temporal characteristics. Additionally or alternatively, in one embodiment, the matching of a learned pattern of one, in particular the first, data set in a new, in particular the second, data set can associate this new data set without information with a known data set with labeled details. In this way, in one embodiment, the amount of data that is available for monitoring and, in particular predictive maintenance can be increased.

In one embodiment, the present invention comprises one or more of the following applications:

1. Localization of anomalies: In one embodiment, the first or second data set comprises temporal characteristics from different situations in a robot application. A temporal characteristic from the same scenario can be regarded as the same type. In one embodiment, certain segments of a live data series are marked. These conspicuous segments are subsequences from the given data series that differ most from previously recorded series of other situations. A user can concentrate on these specific segments to perform an analysis or diagnosis. For example, a user can check a motor torque or a motor current within the time interval as indicated by the characteristic subsequences.

2. Event detection: A peak in the force absorption at a robot end effector can represent a collision. A continuously increasing force level can indicate a planned contact event.

3. Comparison of old data without manual labeling and new, labeled data: In one embodiment to accomplish this, a known pattern that is present in the labeled data is searched for in the unlabeled data. If the same time series subsequence recurs again in the old data, in one embodiment it is determined that the robot was operated under similar conditions. Consequently, a user can transmit his knowledge based on a subsequence from the new output data to analyze old, unlabeled data with less information.

4. Machine learning to learn recurring time series primitives, such as pulses, trapezoidal segments, square wave waves, or the like. In one embodiment, transformations of these primitives are carried out in order to localize variations thereof in a live data series. This function is particularly useful for estimating or observing hidden physical variables of the robot state based on time series segments with certain properties, such as axis friction.

5. Distinguishing between time series from different classes on the basis of typical subsequences of a specific visual form. By observing these differences, in one embodiment, a user can find an explanation for time series from different classes.

6. Automatic grouping of time series data without human intervention: in one embodiment, a user is provided with representative patterns for each time series data group.

Activation within the meaning of the present invention can, in particular comprise localizing and/or embedding within the meaning of the present invention, and vice versa.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system according to an embodiment of the present disclosure; and

FIG. 2 illustrates a method according to an embodiment of the present disclosure.

### DETAILED DESCRIPTION

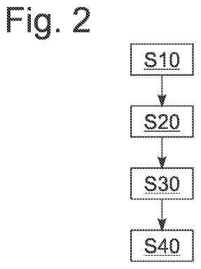

In a training phase (FIG. 2: steps S10, S20), a first data set is obtained with a temporal characteristic x₁(t) of a state parameter of a robot 1 (FIG. 2: step S10). In the embodiment, the state parameter is an example of a drive torque control error.

Subsequently (FIG. 2: step S20), an artificial neural network is trained which has a first autoencoder with an encoder 11 which maps the first data set to temporal characteristic patterns and their activation, and a decoder 12 which reconstructs the first data set with these time course patterns, and a second autoencoder with an encoder 21 which maps the temporal characteristic patterns and their activation to pattern groups, and a decoder 22 which reconstructs the temporal characteristic patterns and their activation with these pattern groups.

In a monitoring phase (FIG. 2: steps S30, S40), a second data set x₂(t) is obtained with a temporal characteristic of the state parameter of the robot 1 (FIG. 2: step S30).

In a step S40, one of the pattern groups of the trained second autoencoder is identified within the second data set and marked in the second data set.

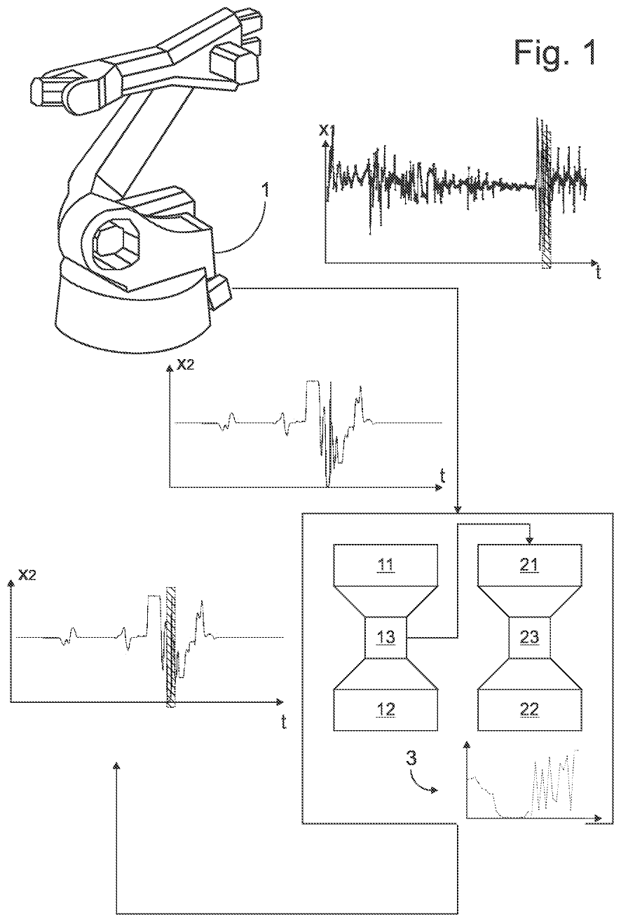

In FIG. 1, this pattern group is indicated by a hatched rectangle with a dashed edge: first, temporal characteristic patterns and their activation, which are initially assigned randomly in the latent space 13 of the first auto code, are learned, or the first autoencoder is trained, such that it reconstructs the temporal characteristic x₁(t) as best as possible.

The temporal characteristic patterns and activations learned in this way are input into the second autoencoder. In its latent space 23, all possible combinations of time course patterns and activations are initially randomly assigned.

The second autoencoder is now trained such that it reconstructs the temporal characteristic patterns and activations from the first autoencoder (“low-level time series subsequences”) as best as possible.

In doing so, it is recognized that the temporal characteristic pattern 3 shown in FIG. 1 only occurs once at a specific point in the temporal characteristic x₁(t) which is indicated in FIG. 1 by a hatched rectangle with a dashed edge.

Now this time course pattern 3 is searched for or identified and marked in the new temporal characteristic x₂(t) which is indicated in FIG. 1 by a hatched rectangle with a dashed border.

The temporal characteristic x₂(t) is recorded, for example, in a work process of the robot 1.

In this way, a significant time interval can be detected in the temporal characteristic x₂(t) or work process, for example a collision, an environmental contact, a robot anomaly or the like.

In this way, on the basis of this identified temporal characteristic pattern, the operation of the robot can be analyzed, monitored and/or modified in step S40, for example, when a (certain) robot anomaly occurs, a predictive maintenance can be correspondingly initiated. Likewise, for example, when a planned environmental contact is detected, a characteristic of the drive torque control error due to the environmental contact can be analyzed in more detail or the like.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1-10. (canceled)

11. A method for analyzing an operation of a robot, the method comprising:
(a) performing a training phase, including:
obtaining with a robot controller a first data set having at least one temporal characteristic of at least one state parameter of a first robot, and
training an artificial neural network, the artificial neural network including:
a first autoencoder having an encoder that maps the first data set to temporal characteristic patterns and corresponding activation, and a decoder that reconstructs the first data set using the mapped temporal characteristic patterns, and
a second autoencoder having an encoder that maps the temporal characteristic patterns and corresponding activation to pattern groups, and a decoder that reconstructs the temporal characteristic patterns and corresponding activation using the pattern groups; and
(b) performing a monitoring phase, including:
obtaining a second data set having at least one temporal characteristic of the at least one state parameter of the first robot or a second robot, and
identifying with a computer at least one of the pattern groups of the trained second autoencoder within the second data set.

12. The method of claim 11, wherein the first autoencoder includes at least one variational autoencoder.

13. The method of claim 11, wherein the encoder of the second autoencoder includes at least one attention-based artificial neural network.

14. The method of claim 13, wherein the at least one attention-based artificial neural network is at least one multi-head attention block.

15. The method of claim 11, wherein the decoder of the second autoencoder has at least one capsule neural network.

16. The method of claim 11, wherein at least one of:
the at least one state parameter depends on at least one of”
at least one position of a robot-fixed reference, at least one orientation of a robot-fixed reference, or of at least one axial load of the robot; or
the at least one state parameter is detected by at least one sensor.

17. The method of claim 16, wherein the at least one sensor is a sensor of the robot.

18. The method of claim 11, further comprising marking the identified pattern group in the second data set.

19. The method of claim 11, further comprising at least one of:
detecting at least one of a robot anomaly or an event based on the identified pattern group; or
classifying the temporal characteristic of the second data set based on the identified pattern group.

20. The method of claim 11, further comprising at least one of:
analyzing an operation of the first or second robot;
monitoring an operation of the first or second robot; or
modifying an operation of the first or second robot.

21. The method of claim 20, wherein the at least one of analyzing, monitoring, or modifying is based on at least one of:
the identified pattern group;
the detected robot anomaly;
the detected event; or
the classified temporal characteristic of the second data set.

22. The method of claim 21, further comprising:
marking the identified pattern group in the second data set;
wherein the at least one of analyzing, monitoring, or modifying is based on the identified pattern group marked in the second data set.

23. A system for analyzing an operation of a robot, the system comprising:
(a) means for performing a training phase, wherein the training phase includes:
obtaining a first data set having at least one temporal characteristic of at least one state parameter of a first robot, and
training an artificial neural network, the artificial neural network including:
a first autoencoder having an encoder that maps the first data set to temporal characteristic patterns and corresponding activation, and a decoder that reconstructs the first data set using the mapped temporal characteristic patterns, and
a second autoencoder having an encoder that maps the temporal characteristic patterns and corresponding activation to pattern groups, and a decoder that reconstructs the temporal characteristic patterns and corresponding activation using the pattern groups; and
(b) means for performing a monitoring phase, wherein the monitoring phase includes:
obtaining a second data set having at least one temporal characteristic of the at least one state parameter of the first robot or a second robot, and
identifying at least one of the pattern groups of the trained second autoencoder within the second data set.

24. A computer program or computer program product comprising program code stored on a non-transient, computer-readable medium, the program code configured, when executed on a computer, to cause the computer to:
(a) perform a training phase, including:
obtaining a first data set having at least one temporal characteristic of at least one state parameter of a first robot, and
training an artificial neural network, the artificial neural network including:
a first autoencoder having an encoder that maps the first data set to temporal characteristic patterns and corresponding activation, and a decoder that reconstructs the first data set using the mapped temporal characteristic patterns, and
a second autoencoder having an encoder that maps the temporal characteristic patterns and corresponding activation to pattern groups, and a decoder that reconstructs the temporal characteristic patterns and corresponding activation using the pattern groups; and
(b) perform a monitoring phase, including:
obtaining a second data set having at least one temporal characteristic of the at least one state parameter of the first robot or a second robot, and
identifying at least one of the pattern groups of the trained second autoencoder within the second data set.
